(19) United States
(12) Patent Application Publication
(10) Pub. No.: US 2005/0191474 A1
(43) Pub. Date: Sep. 1, 2005

(54) Compositions with low coefficients of friction and methods for their preparation

(76) Inventor: Robert T. Gunn, New York, NY (US)

Correspondence Address: FROMMER LAWRENCE & HAUG, 745 FIFTH AVENUE- 10TH FL., NEW YORK, NY, 10151, US

(21) Appl. No.: 11/099,270

(22) Filed: Apr. 5, 2005

Related U.S. Application Data
(63) Continuation of application No. 10/682,602, filed on Oct. 9, 2003.

(51) Int. Cl. C04B 35/64; B32B 7/02

(52) U.S. Cl. 428/212; 264/667

(57) ABSTRACT

The present invention relates to products that would benefit from durable low friction surfaces which are abrasion, puncture and cut resistant and demonstrate, either in performance and/or laboratory tests, significant improvements in these properties when compared to surfaces coated with low friction materials via traditional methods. Traditionally coated materials would not be able to achieve similar gauge, 1/128 to ½ inch or more, with the same combination of durability, abrasion, puncture or cut resistance as with this invention. Products that could benefit from this invention include, but are not limited to boat hulls, skies, snow boards, snow mobiles, jet skies, conveyor systems, airplane exteriors, surfaces of torpedoes, bullets, missiles and similar armaments. Cars, heavy equipment, machine parts, submarines, treadmills for glides for furniture and equipment, dental tools and appliances, medical implants, internal combustion engines, turbines and all surfaces which require lubrication.

### RELATED APPLICATIONS

Reference is made to U.S. patent application Ser. No. 217,490, filed Mar. 24, 1994, issued as U.S. Pat. No. 5,590,420; Ser. No. 389,759, filed Feb. 14, 1995, issued as U.S. Pat. No. 5,829,057; Ser. No. 753,731, filed Oct. 23, 1996, issued as U.S. Pat. No. 5,752,278; Ser. No. 08/968,008, filed Nov. 12, 1997, issued as U.S. Pat. No. 6,061,829; Ser. No. 08/968,377, filed Nov. 12, 1997; and Ser. No. 09/021,352, filed Feb. 10, 1998, issued as U.S. Pat. No. 6,143,368. This application claims priority to U.S. Provisional Application U.S. Ser. No. 60/165,530, filed Nov. 15, 1999, all of which are incorporated herein by reference.

### FIELD OF THE INVENTION

The present invention is directed to a composition having low coefficient of friction. More particularly, the invention provides a combination of at least two or more materials, such as ultra-high molecular weight polyethylene and ethylene methyl acrylate copolymer fibers, wherein one of the materials has a low coefficient of friction. Further, the invention is directed to a method and process for manufacturing the composition.

Documents cited in the following text are incorporated herein by reference.

### BACKGROUND OF THE INVENTION

Low-friction materials and components possess commercially desirable properties. Not only do such materials have increased wear resistance because of improved sliding properties, they also achieve higher performance through reduced frictional loss. Low-friction materials traditionally are produced by a number of methods. Such methods include, for example, applying an external lubricant to a finished product, coating the material with a low-friction polymer layer, or adding inactive agents, such as spheroidal beads, during the formulation of the material. Other methods include forming multi-layer materials wherein one side has a low-friction surface.

In the patent literature, there are various methods of forming low-friction materials with improved sliding properties and increased wear resistance. For example, U.S. Pat. No. 4,138,524 relates to a method of forming an article with an integral protective surface having a low coefficient of friction. Low friction is achieved by inserting chemically inactive spheroidal beads into a bonding material, wherein the density differential allows the beads to migrate to form a low-friction layer.

U.S. Pat. No. 4,996,094 relates to a thermoplastic stretch wrap films with one cling layer and one slip layer. The cling portion is made of low density polymers and the slip portion is made of coextruded high density polyethylene resin.

U.S. Pat. No. 5,750,620 relates to a toughened, low-friction polymeric compositions. A blend of at least two polymers consisting of, for example, polystyrene and polycarbonate, achieve the low friction and wear properties.

U.S. Pat. No. 4,996,094 relates to a stretch wrap film having one surface with cling properties and the other with noncling properties, one noncling property being a slip property exhibited when the noncling surface is in contact with a like surface of itself with relative motion therebetween having the improvement which is comprised of positioning at least one region between the cling and noncling surfaces of the film, said region being of a material selected to provide barrier properties sufficient to maintain the cling and noncling properties of the cling and noncling surfaces. A high number average molecular weight cling additive is used to reduce additive migration and transfer.

U.S. Pat. No. 5,750,620 relates to a polymeric composition including a blend of at least two different polymers selected from the group consisting of polystyrene, polycarbonate, polyetherimide, polyolefin, polysulphone, polyethersulphone, polyacetal, nylon, polyester, polyphenylene sulphide, polyphenylene oxide and polyetheretherketone and at least one elastomer having a tensile modulus less than about 50,000 p.s.i. Alternatively or additionally, the elastomer may be functionalized to graft with at least one of the polymers. The present invention also provides a method of making a tribological wear system by melt-mixing the polymeric composition to improve the wear resistance of a polymeric composite whose surface bears against another surface, thereby causing friction and wear of the polymeric composite.

U.S. Pat. No. 6,093,482 relates to a carbon—carbon composite for friction products comprises an outer friction part and a load bearing structure part supporting the friction part. The friction part contains a mixture of carbon fibers, pitch powder and graphite powder, whereas the structure part is comprised of a pack of alternating layers of the mixture and layers of one member selected from the group consisting of carbon fabrics, carbon-based prepregs and carbon-based, segmented prepregs. The carbon—carbon composite is formed by way of aternatingly piling up layers of a mixture of carbon fibers, pitch powder and graphite powder and layers of one member selected from the group consisting of carbon fabrics, carbon-based prepregs and carbon-based, segmented prepregs one above the other to provide a preform, heating and pressing the preform within a mold to obtain a green body, carbonizing the green body to prepare a carbonized body, impregnating the carbonized body with pitch powder and recarbonizing the impregnated body, and subjecting the impregnated and recarbonized body to chemical vapor infiltration with hydrocarbon gas.

U.S. Pat. No. 4,371,445 relates to a tribological system with plastic/plastic pairings, especially sliding bearings, in which plastics—optionally supported by lubricants—carry out motions in sliding friction relative to one another and at least one of the main sliding partners and/or auxiliary partner is a plastic, containing polar, cyclic compounds, in which the cyclic part of the molecule on at least one side is coupled directly to an atom of Group V (especially nitrogen) or of Group VI (especially oxygen and/or sulfur) of the Periodic System of the elements, or in which the rings contain the atoms mentioned. Excellent sliding conditions are obtained when the polar synthetic materials, containing the cyclic compound(s), either are monovalent, cyclic chain polymers or chain polymers in the form of polyheterocycles (“semi-ladder polymers”) or chain polymers in the form of monovalent polyheterocycles or fully cyclic chain polymers (“ladder polymers”) or homopolymers or copolymers or polymer mixtures within the above groups or of these groups or with other molecules or polymers and either both main polymers are polar and contain different cyclic compounds, while the auxiliary sliding partner however is nonpolar, or that both main sliding partners are nonpolar, while the auxiliary sliding partner however is polar and contains cyclic compounds.

U.S. Pat. No. 4,626,365 relates to a composition for sliding parts, comprising 0.1 to 50 vol % in total of at least one selected from the group (A) consisting of FEP, PFA, ETFE, PVDF, PCTFE and EPE; 0.1 to 35 vol % of compound metal oxide; and the balance PTFE, the total content of components other than PTFE ranging between 0.2 and 70 vol %. Such composition may further contain at least one of metal oxide, metallic lubricant, metal sulfide, metal fluoride, carbonic solid lubricant, fibrous material, ceramics.

U.S. Pat. No. 4,812,367 relates to a material for a low-maintenance sliding surface bearing comprises a metallic backing and on said backing a bearing layer comprising PVDF and an additive for improving the friction and sliding properties. To meet more stringent requirements regarding hygiene, the bearing layer is free of lead and contains 0.5 to 3% by weight of a non-toxic metal oxide power and 10 to 40% by weight of glass microspheres.

U.S. Pat. No. 4,847,135 relates to a composite material for sliding surface bearings, a rough metallic surface is provided with a polymeric matrix, which forms a friction contact or sliding layer over the rough base surface. To increase the wear resistance, the matrix contains zinc sulfide and/or barium sulfate in a particle size from 0.1 to 1.0 .mu.m and an average particle size of 0.3 .mu.m.

U.S. Pat. No. 5,527,594 relates to optical tape comprising a substrate having a center line average roughness (Ra.sup.A) on one side of 0.005 to 0.5 .mu.m and a tensile strength (F.sub.5) in the longitudinal direction of not less than 8 kg/mm.sup.2, and an optical recording layer formed on the other side of said substrate.

U.S. Pat. No. 5,171,622 relates to a lacquer coating is applied to a laminated metal composite forming a sliding element such as a plane bearing and has particles of solid lubricants incorporated therein to form islets of greater thicknesses than the surrounding film and which serve as lubricant-trapping surface formations. The particles may be of polytetrafluoroethylene, fluorinated graphite or molybdenum disulfide and the lacquer is preferably an epoxy resin-based lacquer.

U.S. Pat. No. 5,763,011 relates to a urethane-resin based coating for reducing friction includes a urethane paint and a first powder. The coating is to be applied to a shaped article which is to be subjected to a heat treatment at a certain temperature after the application of the coating to the shaped article. The first powder has a melting point lower than the certain temperature and a solubility parameter which is smaller than or larger than that of the urethane paint by at least 0.5. The coating optionally further includes a second powder which has a melting point higher than the certain temperature. The coating provides the shaped article with low friction, irrespective of the coating film's thickness

U.S. Pat. No. 5,866,647 relates to a polymeric based composite bearing is injected molded of a thermoplastic material reinforced with a high strength fiber and reinforcing beads. Typically, the high strength fiber is selected from the group consisting of aromatic polyamide fiber, high strength/high purity glass fiber, carbon fiber, boron fiber, and metallic fibers. The reinforcing spheres are selected from the group consisting of glass beads, boron nitride beads, silicon carbide beads and silicon nitride beads. The thermoplastic matrix material may consist of polyamide, polyacetal, polyphenylene sulfide, polyester and polyimide. Preferably, the composite bearing comprises between about 5 to about 35 percent weight of the high strength fiber, between about 5 to about 15 percent weight percent of the reinforcing spheres, and between about 50 to about 90 weight percent of the thermoplastic matrix material. The bearing may be injection molded by blending the composite material, heating the composite material to a temperature above its melting temperature, injecting the composite material into a mold cavity, and demolding the bearing after the temperature of the bearing drops substantially below the melting temperature.

U.S. Pat. No. 3,781,205 relates to a composite bearing comprising a backing member to which there is secured a dimensionally stable bearing surface layer comprising a solid lubricant selected from the group consisting of the sulfides, selenides, and tellurides of molybdenum, tungsten, and titatanium, lead diiodine, boron nitride, carbon, graphite, and polytetrafluoroethylene and fibers of a material characterized by a heat distortion temperature exceeding that of polytetrafluoroethylene and selected from the class consisting of aromatic polyamides, carbon, graphite, aromatic polysulfones, aromatic polyimides and aromatic polyester-imides.

U.S. Pat. No. 4,104,176 relates to a porous lubricant-impregnated bearing comprising a matrix of closely packed, discrete particles, such as glass microspheres, bonded together with a bonding material that is different from the particles, such as a cured organic bonding material, and that only partially fills the interstices between the particles; and a migratable lubricant dispersed in the unfilled interstices.

U.S. Pat. No. 5,080,969 relates to a composite friction material for brakes comprising a main friction material containing thermosetting resin as a binder, and a layer of high friction material with a higher friction coefficient than said main friction material for exhibiting a high braking power on initial application, which high friction layer is provided on the surface of said main friction material and contains a phenol resin of not more than 5 wt. %.

U.S. Pat. No. 4,201,777 relates to a unitary carbonaceous body consists of turbostratic carbon formed with a superficial graphitized portion in situ, preferably by passing a high-amperage electric current through this portion.

U.S. Pat. No. 3,980,570 relates to a sliding member having anti-frictional and anti-static properties for a tape or film cassette of an audio- or video-tape recorder or a movie projector, comprising a thermoplastic resin containing 5 to 90% by weight of carbon fiber, said member having less than 10.sup.8 ohms of surface resistance and also having a coefficient of dynamic friction of less than 0.2.

U.S. Pat. No. 5,082,512 relates to seizure resistance of boronized sliding material improved by surface microstructure, i.e., co-existence of the Fe₂B phase and Fe₃B phase.

U.S. Pat. No. 5,093,388 relates to a high friction brake shoe formulation having a high static friction coefficient in shear of about 1.5 and low adhesion to materials having microscopic pores therein in contact with said brake shoe formulation which comprises a mixture of about 75 phr of neoprene W rubber and about 25 phr of neoprene WHV rubber; a first curing system comprising about 1 phr of a fatty acid, about 5 phr of ZnO, and about 1-3 phr of MgO; and a second curing system comprising about 1.25 phr of sulfur and about 0.6 phr of a sulfur accelerator; together with about 50 phr of a reinforcing agent of N555 or N650 carbon black.

U.S. Pat. No. 5,508,109 relates to a fiber blend for use in friction materials. The fiber contains a blend of a highly fibrillated fiber, such as a fibrillated polyacrylonitrile fiber and a fiber with a high carbon content, such as an oxidized carbon fiber precursor.

U.S. Pat. No. 5,811,042 relates to a composite friction or gasketting material is disclosed having a combination of thermoset or thermoplastic matrix resin, fiber reinforcing material, and aramid particles. The composite material exhibits improved wear resistance when compared with materials having no aramid particles.

U.S. Pat. No. 5,889,080 relates to a method for making a dry blend for use in the preparation of a friction material, a dry blend per se and dry friction materials is disclosed wherein the components thereof include a) fibrillated, organic, synthetic polymer, b) organic, synthetic polymer staple and c) organic, synthetic soluble polymer particles.

It would be desirable to combine two or more materials, wherein at least one of the materials has a low coefficient of friction, separating the materials into discrete layers and molding the materials so as to render the layers bound together, thereby forming at least one side of the finished product with a low coefficient of friction.

### OBJECTS AND SUMMARY OF THE INVENTION

An object of the present invention is to provide a novel composition having low coefficient of friction characteristics. It is a further object of the present invention to provide a composition that is capable of an enhanced physical property, such as, for example, wear, tearing, cutting and puncture resistance as well as reducing and/or minimizing abrasive conditions. It is yet another object of the present invention to provide materials possessing low coefficients of friction for boat hulls and sporting goods and/or equipment and or apparel, such as, for example, skis and surfboards.

In accordance with the present invention, a low-friction polymeric composition is provided comprising a first layer comprised of a first component and a second layer comprised of a second component, wherein the first and second layers are connected to one another, the connection can be permanent or temporary through a conventional method; the first component is a low friction material; the second component can enhance a physical property of the composition and vice versa; and at least one side of the composition can have a low coefficient of friction.

Further, and in accordance with the present invention, a method and/or a process of forming a low-friction composition comprising combining at least first and second components into a mixture; separating the first and second components within the mixture; and molding the components, wherein the first component is present in a first layer and the second component is present in a second layer; the first and second layers are connected and this connection can be either permanent or temporary; the first component is a low friction material and the second component is capable of enhancing a physical property of the composition and vice versa; and at least one side of the composition has a low coefficient of friction.

In this disclosure, “comprises”, “comprising”, and the like can have the meaning ascribed to them in U.S. Patent Law and can mean “includes”, “including”, and the like. These and other objects and embodiments of the invention are provided in, or are obvious from, the following detailed description.

### BRIEF DESCRIPTION OF THE DRAWINGS

In the following detailed description, reference will be made to the accompanying drawings, wherein:

FIG. 1 shows a front elevation view of a first embodiment of a composition in accordance with the present invention; and

FIG. 2 shows a front elevation view of a second embodiment of a composition in accordance with the present invention.

### DETAILED DESCRIPTION

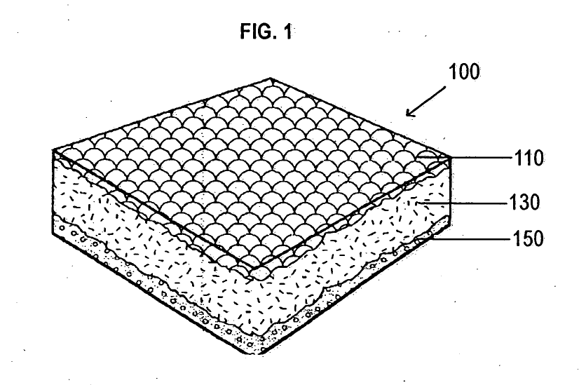

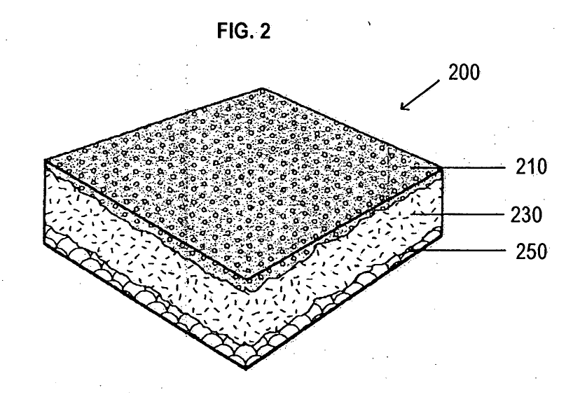

Reference is made to both FIGS. 1 and 2 wherein as preferred embodiments, composition 100 and 200 are illustrated.

As will be appreciated from the following, composition 100 and composition 200.

As will be appreciated from the following, composition 100 is the first embodiment of a composition made in accordance with the present invention. Specifically, composition 100 is a low friction composition made from using ultra high molecular weight polyethylene (UHMWP) having a specific gravity (SPG) of 0.8. Specifically, composition 100 comprises of 10% polyethylene 110, 75% polyester 130 and 15% heavy polymer 150. More particularly, composition 100 is made from mixing the UHMWP with 75% of polyester in liquid form and a polymer in pelletized form with a specific gravity of above 1.9 and pouring the mixture into an open rubber mold with a conventional curing agent. As the polyethylene hardens the UHMWP floats to the top and sides forming a low friction thickness of 10% to 15% by volume on the surface. The dense polymer pellets sink to the bottom and counter the UHMWP at the top to keep the polyester from warping and/or deforming.

Composition 200 is the second embodiment of a composition made in accordance with the present invention. Particularly, composition 200 is a low friction composition made from using ultra high molecular weight polyethylene (UHMWP). Specifically, composition 200 comprises of 10% light polymer 210, 75% polyester 230 and 15% TEFLON® 250. More particularly, composition 200 is made from mixing the UHMWP with polyester in liquid form and a polymer in a pelletized form with the exception that the low friction material used in composition 200 is PTFE (TEFLON®) which has a specific gravity of 2.2. Thus, when mixed with polyester (variable) will sink to the bottom and sides forming a low friction abrasive and cuts-resistant surface. In addition, the third polymer has a specific gravity lower than polyester. Moreover, UHMWP with a specific gravity of 0.8 can also be used.

The present invention provides a low-friction composition, its methods process for making and using it. The composition is comprised of at least two layers, wherein at least one side of the composition has a low coefficient of friction. It will be understood that the layers can be connected and/or attached temporarily and/or permanently together to form an object in which one or more sides of the composition can have a low coefficient of friction. The composition further possess the capability of enhancing one or more physical properties, such as wear-resistance, tear-resistance, durability, cut-resistance, puncture resistance, blister block, and other physical properties, such as, for example, resistance to abrasion, or any combinations thereof. An illustration of the low friction composition contemplated by the present invention comprising three layers are represented schematically in FIGS. 1 and 2.

The composition of the present invention achieves a low coefficient of friction through the use of at least one low friction material. Such low friction materials may include, but not limited to, PTFE, boron, molybdenum sulfide, silicone, silicone/silane modified polymers, graphite, fluorinated high molecular weight polyolefins or cyclic organic compounds, non-modified polyolefins, or other fluorinated polymers. The low friction materials may exist in the form of, but not limited to pelletized spheroidal beads, fibers or powders. A preferred low friction material is TEFLON®. One of ordinary skill in the art would understand that more than one low friction material may be used, such as, for example, a blend of two, three or four different low friction materials. It is to be understood that the present invention has a broad spectrum of utility, for example, the present invention can be used, but not limited to boat hulls, sporting goods, sporting or ordinary apparels which benefit and require low frictional surfaces, such as, for example, skis, sailboats, surfboards and snowboards.

It is further envisioned that other materials may be blended with the low friction material in order to enhance wear-resistance, durability and other physical properties of the composition. Such enhancer materials include, but are not limited to, thermoplastic or thermosetting polyester, epoxies, PVC, thermoplastic or thermosetting polyurethane or other materials. These enhancer materials may be in the form including, but not limited to pellets spheroidal beads, fibers or powders. A preferred enhancer material is an ultra high molecular weight polyethylene. It is envisioned that one or more additional materials can be added to balance the curing, drying or cooling of the combined materials in order to avoid and/or control, for example, cracking, crazing, shrinking or deforming of the composition.

The composition in accordance with the present invention is made from a method of utilizing and/or manipulating the physical properties of the materials in a separation step. The separation step is performed prior to or concurrently with a forming process, preferably a molding process, for example, before the molding operation or during the molding operation. Such molding processes are readily understood to one skilled in the art to include, but are not limited to, pour molding; casting; pressure molding, such as compression, injection, rotational, blow and other forms of high or low pressure molding; and extrusion, such as co- and multi-layer extrusion, with or without rotating dies and/or mandrels.

Once the low friction materials are blended with at least one enhancer material, a separation step is necessary to allow the low friction material to be separated from and migrate to at least one layer of the composition. The separation of the low friction material from the blend may be performed by, for example, vibration; polarization; or externally induced changes in the coefficient of friction, wherein the changes are externally induced by, for example, via radio frequency (“RF”) energy. The physical properties utilized and/or manipulated include, among others, the specific gravity or density of the materials in the blend; the surface area of the materials; and the aspect ratio, i.e., the ratio of a material's length to its breadth.

The following examples are set forth to illustrate examples of embodiments in accordance with the invention, it is by no way limiting nor do these examples impose a limitation on the present invention.

### EXAMPLE 1

### Separation

A) Vibration Utilizing Specific Gravity or Density:

A dry blend mixture of equal size, 0.900 density pelletized polyethylene and a barium sulfate (BaSO₄)-filled low density polyethylene with a density of 1.50, is vibrated, both vertically and horizontally in a compression mold. The vibration causes the heavier pellets to gravitate to the bottom of the mold, leaving the lower density pellets above the heavier density pellets. When the mold is heated, without application of pressure, the heavier density pellets melt and form a dense molten layer at the bottom of the mold. The lighter density pellets melt and form a relatively clear, soft molten layer above the heavier density material. Upon cooling, the molded solid mass consists of a lower layer which is hard, opaque and rigid, while the upper layer is soft, compliant, relatively transparent and soft. Although vibration is the method of separation, a skilled artisan would readily understand that other separation techniques could be used such as, for example, floatation in a liquid whose density is between the densities of the two materials; or use of a fluidized bed.

B) Vibration Utilizing Surface Area

A dry blend mixture of pulverized of a 0.900 density pelletized polyethylene, in which some of the particles are 10 mesh in size and some are 400 mesh in size, is vibrated both vertically and horizontally. The vibration causes the particles of 10 mesh size to accumulate at the bottom of the mold, leaving the smaller 400 mesh particles resting on top of the larger sized particles. When the mold is heated to the melting point of the plastic and quickly cooled, the lower layer will be significantly rougher than the upper layer due to the surface fusion of the larger particles. The upper layer will be smoother and have a lower coefficient of friction than the lower surface due to the surface fusion of the very small particles; wherein the small particles have a significantly greater surface area than the larger particles below them. Although vibration is the method of separation, a skilled artisan would readily understand that other separation techniques could be used.

C) Vibration Utilizing Aspect Ratio

As mentioned above, the aspect ratio of a material is generally taken as the ratio of its length to its breadth. In this example, a dry blend mixture of long and short fibers composed of the same material is vibrated both horizontally and vertically. The shorter fibers will segregate from the longer fibers. Upon the cessation of gas flow during the molding process, the upper and lower surfaces will have significantly different concentrations of the high and low aspect ratio fibers. The higher ratio fibers will exist predominately in the upper layer, while the lower aspect ratio fibers will exist predominately in the lower layer.

D) Polarity and/or Polarizability

A mixture of fibers of polyethylene and ionomer, in which the fibers have the same surface area and aspect ratio, is dispersed in a non-conductive liquid. When two electrodes are placed in the liquid, one having a negative charge and the other a positive charge, the ionomeric fiber will be attracted to one of the electrodes due to the fiber's polarity. The polyethylene fiber, being non-polar, will neither be attracted nor repelled from the electrodes. Consequently, the concentration of ionomer in the vicinity of the electrodes will be higher than in the bulk dispersion. The concentration of polyethylene fibers will be almost equal in the vicinity of the electrodes as in the bulk of the dispersion.

E) Externally Induced Changes in the Coefficient of Friction

Ethylene methyl acrylate copolymer absorbs radio frequency energy. Absorption of radio frequency energy causes the temperature of ethylene methyl acrylate copolymer to increase, softening the surface of the polymer, thereby increasing the polymer's coefficient of friction. A blend of ultra high molecular weight polyethylene and ethylene methyl acrylate copolymer fibers, having identical surface areas and aspect ratios, will very slowly separate if dragged along a glass surface. However, application of a radio frequency field to the blend, with energy sufficiently low so as not to melt the ethylene methyl acrylate copolymer fibers, will cause the ethylene methyl acrylate fibers to lag behind the ultra high molecular weight polyethylene fibers as the blend is dragged along the glass plate. The separation is due to the increase of ethylene methyl acrylate copolymers coefficient of friction due to the higher temperature. The ultra high molecular weight polyethylene, unaffected by radio frequency energy, maintains its normal coefficient of friction.

### EXAMPLE 2

### Molding

A) Pour Molding (Casting)

A particulate mixture of poly (tetrafluoroethylene) and high molecular weight polyethylene, in which the poly (tetrafluoroethylene) and high molecular weight polyethylene particles have identical particle sizes and shapes, is dispersed in liquid, unsaturated polyester resin. A peroxide curing agent is added to the mixture and the blend is mixed thoroughly at ambient temperature. The dispersion is poured into a mold and allowed to rest on a level vibrating table. Prior to the start of the mixture's viscosity increase caused by the onset of polyester cure, the denser PTFE particles sink to the lower surface of the mold while the less dense ultra-high molecular weight polyethylene rises to upper surface of the mixture. After completion of the curing reaction, which may take several hours, depending upon the selection of the peroxide curing agent and the temperature, as is readily understood by the skilled artisan, the bottom layer will consist of predominately poly (tetrafluoroethylene), while the top layer will consist predominately of ultra-high molecular weight polyethylene.

B) Pressure Molding

A blend of pelletized low molecular weight fluorinated ethylene propylene copolymer and polypropylene is melted and injection molded at high pressure and temperature into a closed mold. The fluorinated ethylene propylene copolymer, which is incompatible with polypropylene, will migrate to the surface of the mold. The resulting molded item will have a top layer rich in fluorinated ethylene propylene copolymer and a separate layer rich in polypropylene. A similar result will occur if the molten mixture is extrusion blow molded, compression molded or rotationally molded.

C) Extrusion

A blend of pelletized low molecular weight fluorinated ethylene propylene copolymer and polypropylene is melted and extruded through a stationary, single die. The fluorinated ethylene propylene copolymer congregates on the exterior surface and the polyproylene in the interior surface. Absolute coextrusion, as understood by a skilled artisan, may be obtained by coextruding the materials, where they are not blended and each is fed to a separate extruder and a separate opening or orifice in a common die. In this case, the location of each material is dependent upon the location of the die orifice through which they are extruded. In this case, it is possible to have the die and/or mandrel rotate during the extrusion. Consequently, the separated layers will be circumferentially oriented. The relative orientation of the two layers with respect to each other will depend upon the relative rotational direction and velocity of the die openings through which they are extruded.

It is also understood that the invention is not limited to the detailed description of the invention, which may be modified without departure from the accompany claims.

1. A low friction composition comprising:
a first layer having a first component; and
a second layer having a second component;
wherein the first and second layers are connected to one another; the first component imparts a coefficient of friction to the first layer which is lower than the coefficient of friction of the second layer; and at least the second component enhances the physical properties of the composition.

2. The composition of claim 1, wherein the first component is selected from the group consisting of PTFE, boron, molybdenum sulfide, silicone, silicone/silane modified polymers, graphite, fluorinated high molecular weight polyolefins or cyclic organic compounds, non-modified polyolefins, or other fluorinated polymers.

3. The composition of claim 1, wherein the second component comprises thermoplastic or thermosetting polyester, epoxy, PVC, or thermoplastic and thermosetting polyurethane.

4. The composition of claim 1, further comprising materials that control the curling, drying, cooling, cracking, crazing, checking, shrinking or deforming of the composition.

5. A low friction composition comprising:
a first layer having a first component; and
a second layer having a second component;
wherein the first and second layers are connected to one another; the first component imparts a coefficient of friction to the first layer which is lower than the coefficient of friction of the second layer; and at least the second component enhances the physical properties of the composition.

6. A method of making a low friction composition comprising:
a) combining at least a first component and a second component into a mixture;
b) separating the components within the mixture; and
c) molding the mixture into an integral composite; wherein
the first component is present in a first layer and the second component is present in a second layer; the first and second layers are attached; the first component is a low friction material and the second component enhances the physical properties of the composition; and at least one side of the composition has a low coefficient of friction.

7. The method of claim 5, wherein the separating step comprises vibration, polarization and radio frequency induction of energy.

8. The method of claim 5, wherein the molding step comprises pour molding, casting, pressure molding and extrusion.

9. A boat hull with a low coefficient of friction comprising:
a first layer comprised of a first component; and
a second layer comprised of a second component, wherein
the first and second layers are attached to one another; the first component is a low friction material; at least the second component enhances the physical properties of the composition; and at least one side of the composition has a low coefficient of friction.

10. Sporting goods with a low coefficient of friction comprising:
a first layer comprised of a first component; and
a second layer comprised of a second component, wherein
the first and second layers are attached to one another; the first component is a low friction material; at least the second component enhances the physical properties of the composition; and at least one side of the composition has a low coefficient of friction.
